(19) United States
(12) Patent Application Publication
(10) Pub. No.: US 2007/0024799 A1
(43) Pub. Date: Feb. 1, 2007

(54) DISPLAY DEVICE

(76) Inventors: Syuuichi Kira, Tokyo (JP); Tomoki Nakamura, Tokyo (JP); Masaya Mizunuma, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/456,430

(22) Filed: Jul. 10, 2006

(30) Foreign Application Priority Data
Jul. 29, 2005 (JP) P2005-221040

(51) Int. Cl. G02F 1/1339

(52) U.S. Cl. 349/156

(57) ABSTRACT

A display device that includes: a first substrate on which a second conductive layer to be stacked on a first conductive layer through an insulating layer is formed; a second substrate facing the first substrate; and a pillar-shaped spacer that holds the first substrate and the second substrate so that a gap between the first substrate and the second substrate is substantially uniform. The pillar-shaped spacer is disposed above the first conductive layer. The pillar-shaped spacer is disposed above the first conductive layer through a hole provided in the second conductive layer in a region where the first conductive layer and the second conductive layer are stacked through the insulating layer.

### BACKGROUND OF THE INVENTION

1. Field of the Invention

The present invention relates to a display device having pillar-shaped spacers adapted to maintain a thickness of a liquid crystal layer sandwiched between two substrates opposed to each other and a gap between the two substrates opposed to each other in a peripheral region of the liquid crystal layer at constant values, respectively.

2. Description of the Related Art

In a related liquid crystal display apparatus, pillar-shaped spacers are formed on light shielding layers. The density of the number of pillar-shaped spacers formed in an off-display area is higher than that of pillar-shaped spacers formed in a display area (see, for example, JP-A-2005-70808 (see page 3, left column, lines 31 to 40, FIG. 1)).

In the related liquid crystal display apparatus disclosed in JP-A-2005-70808, the thickness of an array substrate in a display area differs from that of the array substrate in an off-display area due to the influence of the film thicknesses of gate lines, auxiliary capacitive lines, or semiconductor layers. This causes a difference in thickness (hereunder referred to as a panel gap) between a liquid crystal layer provided in a display area and that provided in an off-display area. Thus, the related liquid crystal display apparatus has a problem in that the pillar-shaped spacers can be disposed only in the display area, or only in a part of the off-display area among the display area and a peripheral region of the display area.

### SUMMARY OF THE INVENTION

The invention is accomplished to solve the aforementioned problem. Accordingly, an object of the invention is to provide a display device enabled to serve as a high display quality display apparatus without unevenness of the gap even when pillar-shaped spacers are disposed in any place other than the display area.

According to an aspect of the present invention, a display device includes: a first substrate on which a second conductive layer to be stacked on a first conductive layer through an insulating layer is formed; a second substrate facing the first substrate; and a pillar-shaped spacer that holds the first substrate and the second substrate so that a gap between the first substrate and the second substrate is substantially uniform. The pillar-shaped spacer is disposed above the first conductive layer. The pillar-shaped spacer is disposed above the first conductive layer through a hole provided in the second conductive layer in a region where the first conductive layer and the second conductive layer are stacked through the insulating layer.

According to the invention, the pillar-shaped spacers are disposed above the first conductive layer. Also, in the portion in which the first conductive layer and the second conductive layer are stacked through the insulating layer, the pillar-shaped spacers are disposed above the first conductive layer through the hole provided in the second conductive layer. Thus, a gap provided between a first substrate and a second substrate formed above the first conductive layer in a portion, in which the second conductive layer is not stacked on the first conductive layer, so that the pillar-shaped spacers are disposed therein, can be set to be equal to a gap which is provided between the first substrate and the second substrate in a portion in which the second conductive layer is stacked on the first conductive layer, so that the pillar-shaped spacers are disposed therein. Consequently, a display device serving as a high display quality display apparatus without unevenness of the gap can be obtained.

### BRIEF DESCRIPTION OF THE DRAWINGS

FIG. 1 is a plan view schematically illustrating the configuration of a display device according to a first embodiment implementing the invention;

FIG. 2 is an explanatory enlarged view illustrating the planar structure of pillar-shaped spacers and also illustrating a part A of the display device shown in FIG. 1;

FIG. 3 is a partly cross-sectional explanatory view illustrating portions of the display device shown in FIG. 1, in which pillar-shaped spacers are disposed;

FIG. 4 is a partly cross-sectional explanatory view illustrating another means for disposing pillar-shaped spacers in the display device shown in FIG. 1;

FIG. 5 is a partly cross-sectional explanatory view illustrating still another means for disposing pillar-shaped spacers in the display device shown in FIG. 1; and

FIG. 6 is a partly cross-sectional explanatory view illustrating apart of a display device, in which pillar-shaped spacers are disposed, according to a second embodiment implementing the invention.

### DETAILED DESCRIPTION OF THE INVENTION

### First Embodiment

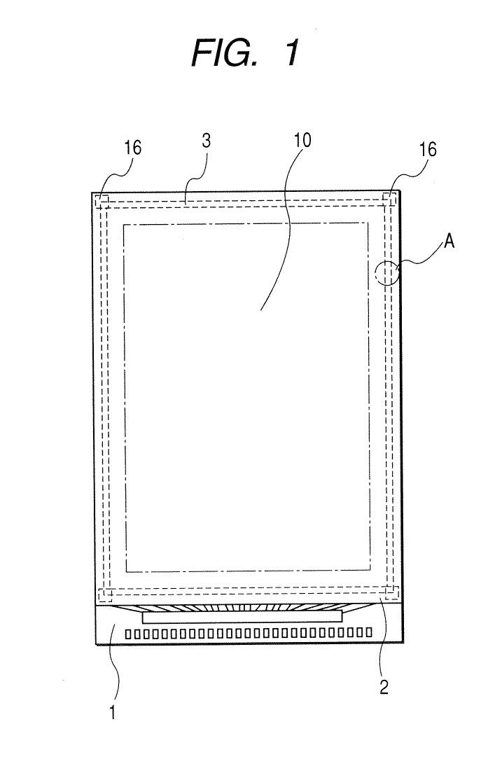

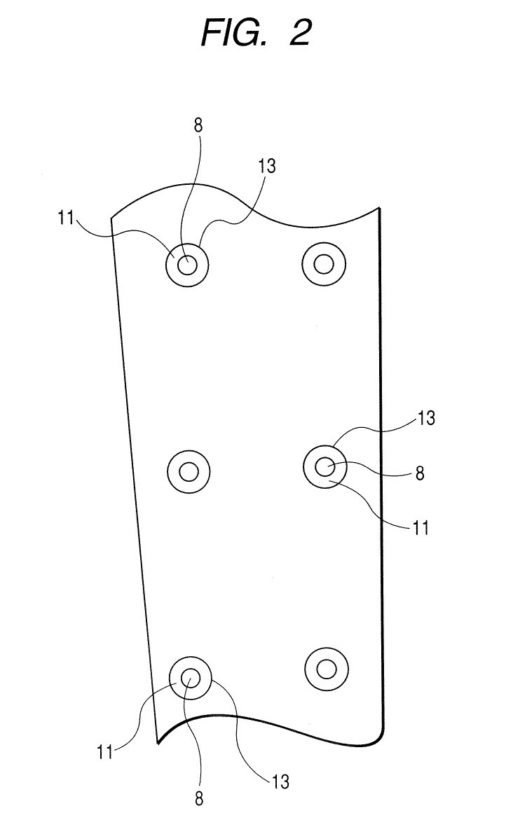

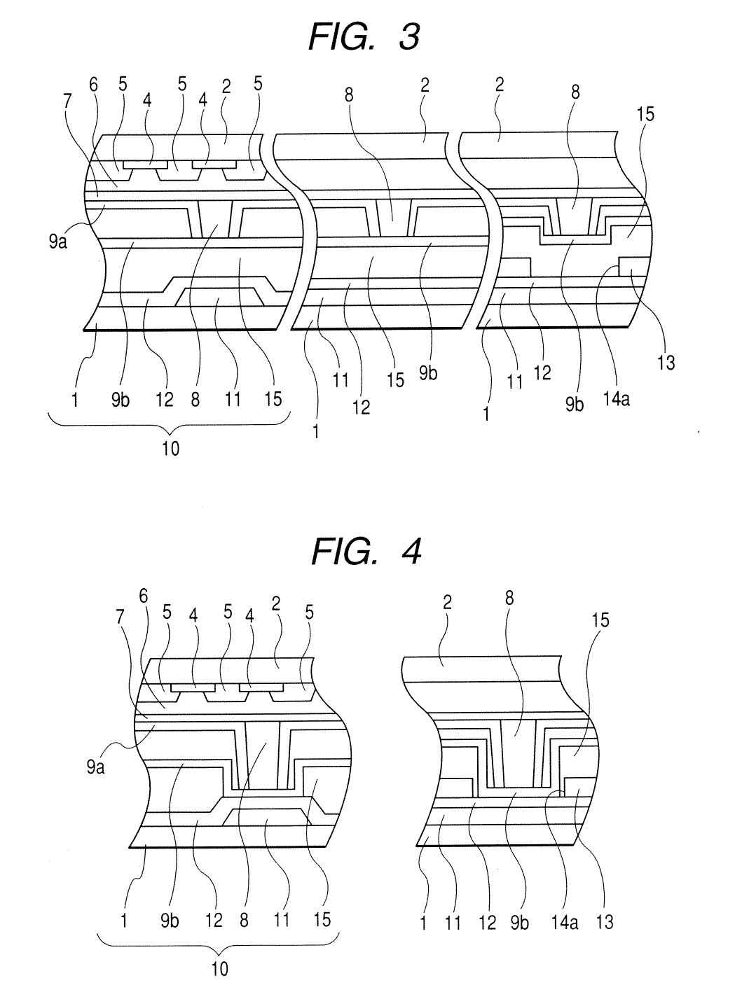

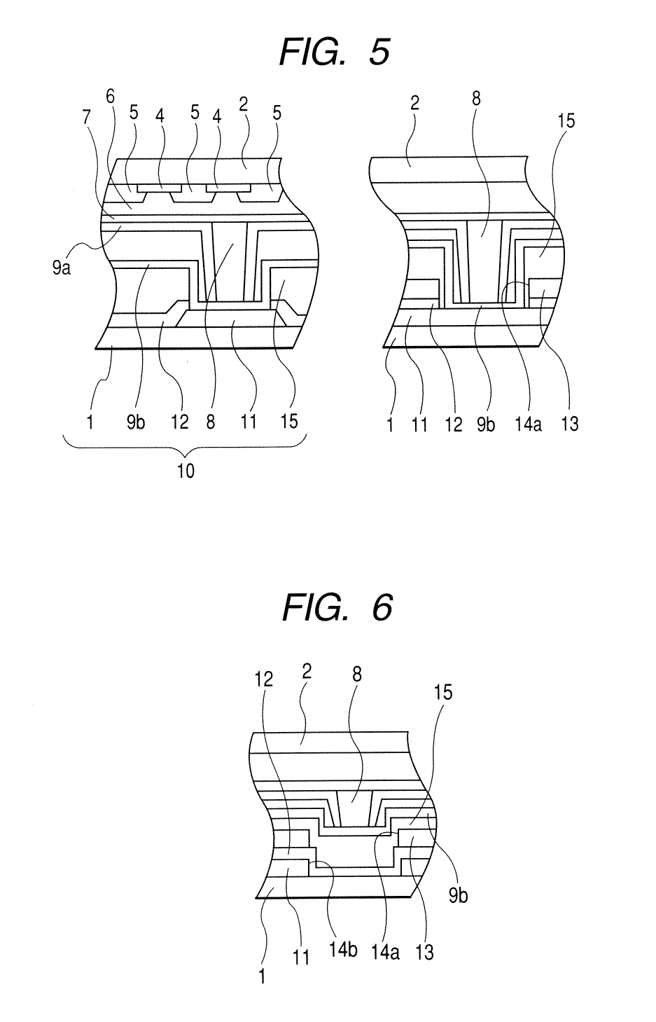

FIG. 1 is a plan view schematically illustrating the configuration of a display device according to a first embodiment for implementing the invention. FIG. 2 is an explanatory enlarged view illustrating the planar structure of pillar-shaped spacers and also illustrating a part A of the display device shown in FIG. 1. FIG. 3 is a partly cross-sectional explanatory view illustrating portions of the display device shown in FIG. 1, in which pillar-shaped spacers are disposed. FIG. 4 is a partly cross-sectional explanatory view illustrating another means for disposing pillar-shaped spacers in the display device shown in FIG. 1. FIG. 5 is a partly cross-sectional explanatory view illustrating still another means for disposing pillar-shaped spacers in the display device shown in FIG. 1.

As shown in FIGS. 1 to 5, in the display device according to the invention, an array substrate obtained by forming thin film transistors (hereunder referred to as TFTs) on a first substrate 1, which is a transparent insulating substrate, such as a glass substrate, and a counter substrate obtained by forming a color filter (hereunder referred to as CF) on a second substrate that is a transparent insulating substrate, are disposed to face each other, similarly to the related display device. Also, liquid crystals are sealed in a region surrounded by a sealing material 3 in the gap between this first substrate 1 and the second substrate 2.

Next, the process of manufacturing this counter substrate is described below.

First, a Cr-film is formed on the second substrate 2 by a sputtering apparatus. Subsequently, a black matrix (hereunder referred to as a BM) 4, which is a light shielding film, is formed by a photolithographic method. Although the Cr-film is formed by the sputtering method in this embodiment, a bi-layer film including a metal Cr-layer and a Cr-oxide layer may be employed, instead of the Cr-film. Alternatively, other kinds of films, such as Ni-film and Al-film, may be employed. The method of forming the film is not limited to the sputtering method. Other kinds of methods, such as an evaporation method, may be employed. Also, a resin BM obtained by dispersing a light shielding agent in a resin may be used.

Then, red (R) pigment is applied onto the BM. Subsequently, the application of resist, an exposure step, and a development step are performed to thereby perform the patterning of the pigment. Thus, a red colored layer 5 is formed between the BMs 4. This process is repeated to form a green colored layer 5 and a blue colored layer 5. Consequently, colored layers 5 respectively corresponding to three primary colors are formed. Incidentally, each of the colored layers 5 is made to overlap with the BM 4. Although a pigment dispersion method is employed in the first embodiment, the method employed according to the invention is not limited thereto. A dyeing method, an electropainting method, or a printing method may be performed.

Then, a transparent overcoating film 6 is applied thereon. Subsequently, planarization is performed. Also, a common electrode 7 constituted by a transparent conducting film used to drive the liquid crystals is formed. Incidentally, this overcoating film 6 has heat resistance and chemical resistance and serves to protect the colored layers 5.

Also, pillar-shaped spacers 8 adapted to hold substantially the uniform gap between the first substrate 1 and the second substrate 2. The pillar-shaped spacers 8 are formed by performing a photolithography step after a resin layer is applied thereon. The pillar-shaped spacers 8 are substantially circular in cross-section. The diameter of the cross-section of the pillar-shaped spacer 8 is about 15 μm to 20 μm. The height of the pillar-shaped spacer 8 is about 4 μm.

Although the shape of an end surface of the pillar-shaped spacer 8 is set to be substantially circular in the first embodiment, the shape of the end surface of the pillar-shaped spacer 8 is not limited thereto. For example, the shape of the end surface of the pillar-shaped spacer 8 may be a substantially quadrangle or a substantially polygon.

The pillar-shaped spacers 8 are placed so that the density of the number of the pillar-shaped spacers 8 provided on the counter substrate is equal to or more than 0.0001 [(the cross-section of the pillar-shaped spacer) μm²/μm²] and is equal to or less than 0.005 [(the cross-section of the pillar-shaped spacer) μm²/μm²].

In a case where the pillar-shaped spacers 8 are placed over the entire counter substrate so that the density of the number of the pillar-shaped spacers 8 provided on the counter substrate is equal to or less than 0.0001 [(the cross-section of the pillar-shaped spacer) μm²/μm²], a compression failure of the pillar-shaped spacer 8 is caused by an atmosphere pressure of 98000 Pa when the liquid crystals are injected.

The breaking strength of a photosensitive resin, such as an acrylic resin, used as the material of the pillar-shaped spacer 8 is considered to be about 9.8×10⁷ to 9.8×10⁸ Pa. Therefore, the value obtained by the atmospheric pressure (98000 Pa) divided by the compression failure strength ranges from 0.001 to 0.0001. The lower limit value of the density of the number of the pillar-shaped spacers 8 is 0.0001 [(the cross-section of the pillar-shaped spacer) μm²/μm²].

In a case where the pillar-shaped spacers 8 are disposed over the entire counter substrate so that the density of the number of the pillar-shaped spacers 8 provided on the counter substrate is equal to ore more than 0.005 [(the cross-section of the pillar-shaped spacer) μm²/μm²], the pillar-shaped spacers 8 cannot ensure a sufficient amount of compressive deformation.

Thus, when the liquid crystals thermally expand due to rise in temperature of the liquid crystal display apparatus, the array substrate supported by the pillar-shaped spacers 8 is separated from the pillar-shaped spacers 8. When the pillar-shaped spacer 8 cannot support the array substrate, a pressure is not uniformly applied to the substrate. Thus, display unevenness occurs in the liquid crystal display apparatus. Also, when the liquid crystals thermally contract due to drop in temperature of the liquid crystal display apparatus, the reaction force of the pillar-shaped spacer 8 against the substrate increases to thereby accelerate reduction in the internal pressure of the liquid crystals. Consequently, the problem of generation of bubbles is caused.

Thus, the display unevenness can be suppressed by placing the pillar-shaped spacers 8 so that the density of the number of the pillar-shaped spacers 8 provided on the counter substrate is equal to or more than 0.0001 [(the cross-section of the pillar-shaped spacer) μm²/μm²] and is equal to or less than 0.005 [(the cross-section of the pillar-shaped spacer) μm²/μm²].

Also, an alignment layer 9a is applied thereon. Then, baking and rubbing are performed thereon.

Next, the process of manufacturing this array substrate is described below.

First, electrically conducting films made of Al, Cr, Mo, Ti, and W are formed on the first substrate by the sputtering apparatus. Then, a photolithography step, an etching step, and a resist removing step are performed to thereby form a first conductive layer 11 including gate electrodes, gate lines, common capacitive lines, or lead lines in an area other than display area 10.

Subsequently, insulating layers 12 made of, for example, SiNx and semiconductor films, such as an a-Si film, are formed on the first substrate 1, on which the first conductive layer 11 is formed. Then, the surfaces of the semiconductor films are doped with impurities, such as P and As, to thereby form an n+a-Si layer serving as an ohmic contact layer. Then, a photolithography step, an etching step, and a resist removing step are formed to thereby form the semiconductor layer.

Subsequently, electrically conducting films made of Al, Cr, Mo, Ti, and W are formed on the first substrate by the sputtering apparatus. Then, a photolithography step, an etching step, and a resist removing step are performed to thereby form a second conductive layer 13 including gate electrodes, gate lines, common capacitive lines, or lead lines in an area other than display area 10.

At that time, in the same step of forming the second conductive layer 13, a hole 14a is formed in the second conductive layer 13 in a part corresponding to the aforementioned pillar-shaped spacers 8 in an area, in which the first conductive layer 11 and the second conductive layer 13 are stacked through the insulating layer 12, other than the display area 10. Incidentally, this hole 14a has a cross-section shaped concentrically with that of the pillar-shaped spacer 8 and also has a depth substantially equal to the thickness of the second conductive layer 13.

In a case where a removed part (that is, the hole 14a) of the second conductive layer 13 is large, the volume of the lines constituted by the second conductive layer 13 is reduced. Thus, the resistance of the lines is increased. There is a fear of deterioration of the display quality. Therefore, it is preferable that the cross-section of the removed part (the hole 14a) of the second conductive layer 13 is nearly equal to the cross-section of a region, in which the pillar-shaped spacer 8 is in contact with the array substrate, that is, the cross-section of a leading end of the pillar-shaped spacer 8.

However, in consideration of the overlapping deviation (that is, the bonding accuracy) between the first substrate 1 and the second substrate 2 and variation in the finish (that is, the exposure accuracy) of the pillar-shaped spacer 8, it is necessary to provide the holes 14a, which is formed by removing a part from the second conductive layer 13, not only in an area, in which the pillar-shaped spacer 8 provided on the counter substrate is in contact with the array substrate, but in an area broader than the area, in which the pillar-shaped spacer 8 is in contact with the array substrate. More specifically, it is preferable to remove an area whose cross-section is 1.5 to 4 times the cross-section of an end of the pillar-shaped spacer 8.

Subsequently, a SiNx-film serving as an interlayer insulating film 15 is formed. Then, a photolithography step, an etching step, and a resist removing step are performed to thereby form a contact hole. Subsequently, a transparent conductive film, such as an ITO-film, is formed. Then, a photolithography step, an etching step, and a resist removing step are performed to thereby form pixel electrodes and terminal portions.

In the aforementioned process, the TFTs are formed. Also, the array substrate, on which the TFTs are provided like an array, is used as the display device.

Subsequently, cleaning is performed on this array substrate. Then, an alignment layer 9b is applied thereon. Subsequently, baking, and rubbing are performed thereon. Incidentally, the direction of rubbing the alignment layer 9b provided on the array substrate is set to be twisted by 90 degrees from the direction of rubbing the alignment layer 9a provided on the counter substrate. Thus, a TN-mode liquid crystal display device is formed.

The array substrate and the counter substrate formed in this manner are bonded by the sealing material 3. Then, liquid crystal materials are injected thereinto. Consequently, the liquid crystal display device is formed.

The liquid crystal display device, in which the backlight unit is disposed on the rear surface of the liquid crystal device, is configured so that the liquid crystals are sandwiched between paired substrates on which a plurality of pixels are formed, that liquid crystal molecules are aligned by performing alignment processing on the surface of the substrate, and that a voltage is then applied among a plurality of electrodes formed on a pair of or one of the substrates. Then, voltages to be applied to the liquid crystals are controlled at thin film transistors (TFTs) formed respectively corresponding to a plurality of pixels. Consequently, an amount of light outputted from a backlight light source is changed to thereby form an image.

In a case where the liquid crystals are used in a light shutter, the accuracy of the thickness (that is, the panel gap) of the liquid crystal layer affects display characteristics, such as a light transmission, a contrast ratio, and a response speed. Thus, it is important to maintain the accuracy of the is panel gap at a uniform level. Generally, a bead-like spacer or a pillar-shaped spacer 8 is user as a means therefor.

Although bead-like spacers are sprayed by, for example, a dry spraying method, this method has problems in unevenness of the gap due to unevenness of spraying the spacers, unevenness of the gap due to aggregation of the spacers, and light leakage due to alignment unevenness in the vicinity of the spacer.

A means for solving the problems is a method of forming the pillar-shaped spacers 8 on one of the substrates. The pillar-shaped spacers 8 can be selectively disposed. Thus, dispersion unevenness, which would occur in the case of the bead-like spacers, does not occur in the case of the pillar-shaped spacers. The precise film formation process is used for the pillar-shaped spacers. Thus, the pillar-shaped spacers excel in evenness in the height thereof that determines the gap. Also, because the pillar-shaped spacers can be selectively formed in the light shielding area, the influence of alignment unevenness can be circumvented.

For example, the pillar-shaped spacers 8, which are in contact with the array substrate, are disposed above the first conductive layer 11. Especially, the pillar-shaped spacers 8 are arranged in a portion, in which the second conductive layer 13 is not stacked on the first conductive layer 11, for example, above the gate lines in the display area 10 provided on the array substrate. Also, outside the display region 10, the pillar-shaped spacers 8 are disposed above the common lines through the holes 14a provided in the second conductive layer 13, for example, holes provided in the source lead lines.

Incidentally, in the related liquid crystal display device using the array substrate on which a part of the second conductive layer 13 is not removed, the height of a portion outside the display area 10 on the array substrate is higher than the height of a portion in the display area 10. Thus, the panel gap in the display area 10 differs from that outside the display area 10, so that the panel gap is uneven. Slight gap unevenness in the peripheral portion is observed.

Although the foregoing description of the first embodiment has described the case that the BM 4 and the three colored layers R, G, and B are disposed on the counter substrate, as long as the light leakage from between adjacent pixels can be prevented, it is unnecessary to dispose the BM 4 on the counter substrate. In a case where color display using the colored layers is not performed, it is unnecessary to dispose the colored layers 5 thereon. It is sufficient to dispose only the BM 4 thereon.

Although the foregoing description of this embodiment has described the TN mode, in which the value of the panel gap is 4.3 μm, the height of the pillar-shaped spacers 8 is not limited to 4 μm. Preferably, the height of the pillar-shaped spacers 8 is set within a range of the height of the pillar-shaped spacers 8, which can be set in the process. Gap adjustment according to similar techniques can be applied in applicable display modes that are, for instance, IPS (In-Plane Switching) mode utilized birefringent effect of liquid crystals, ECB (electrically controlled birefringence) mode, a VA (vertical alignment) mode, and OCB (optical compensated birefringence) mode.

Also, in the first embodiment, the gap between both the substrates in the display area 10 is made to be equal to that therebetween outside the display area 10 in a portion, in which the pillar-shaped spacers 8 are disposed, by forming the hole 14a only in the second conductive layer 13. However, the gap between both the substrates in the display area 10 can be made to be equal to that therebetween outside the display area 10 in a portion, in which the pillar-shaped spacers 8 are disposed, by forming holes in the first conductive layer 11 and the interlayer insulating film 15 serving as an upper layer of the second conductive layer 13, in which the pillar-shaped spacers 8 are disposed, as illustrated in FIG. 4. In this case, the hole formed in the interlayer insulating film 15 is formed in the same step as the step of forming the contact hole in the interlayer insulating film 15.

Also, the gap between both the substrates in the display area 10 can be made to be equal to that therebetween outside the display area 10 in a portion, in which the pillar-shaped spacers 8 are disposed, by forming holes in the first conductive layer 11, the interlayer insulating film 15 serving as an upper layer of the second conductive layer 13, and the insulating layer 12, in which the pillar-shaped spacers 8 are disposed, as illustrated in FIG. 5. In this case, the holes formed in the interlayer insulating film 15 and the insulating layer 12 are collectively formed.

However, in the case of forming the holes in the insulating layer 12 above the gate lines, which are the first conductive layer 11 in the display area 10, and in the interlayer insulating film 15, there is a fear of applying unnecessary electrical potential to the gate lines. Thus, it is preferable to form holes only in the interlayer insulating film 15 or the insulating layer 12 outside the display area 10. In this case, the value of the panel gap outside the display area 10 can optionally be adjusted by mixing gap adjustment materials, such as microrods, into the sealing material 3.

Thus, the gap between both the substrates in the display area 10 can be adjusted to that therebetween outside the display area 10 by appropriately selecting the layers, in which the holes are formed, from the layers formed in the array substrate in which the pillar-shaped spacers 8.

In the first embodiment, it is unnecessary to dispose the pillar-shaped spacers 8 in the transfer electrode portion 16 on the counter substrate, which electrically conducts the first conductive layer 11 provided on the first substrate 1 into the common electrode 7 provided on the second substrate 2.

In a case where the pillar-shaped spacers 8 are disposed in the transfer electrode portion 16 of the counter substrate, the pillar-shaped spacers 8 serve as column supports, it becomes difficult to attach the material, which electrically conducts the array substrate to the counter substrate, thereto by pressure. Thus, a margin of resistivity of conductive layers is reduced. However, in a case where the pillar-shaped spacers 8 are not disposed in the transfer electrode portion 16 of the counter substrate, the material used to electrically conduct the array substrate to the counter substrate can easily be attached thereto by pressure. Therefore, a sufficient margin of resistivity of conductive layers can be realized. Thus, the conducting of the array substrate to the counter substrate can be facilitated by disposing no pillar-shaped spacers 8 in the transfer electrode portion 16. Consequently, it is preferable, because a display device, which is free from a conduction failure, can be obtained.

Also, in the first embodiment, it is unnecessary to dispose the pillar-shaped spacers 8 in an area, to which the sealing material 3 for sealing the liquid crystals is applied, in the gap between the first substrate 1 and the second substrate 2. Consequently, the attachment of the sealing material 3 is facilitated. This is preferable, because the display device having a high degree of adhesion between the array substrate and the counter substrate can be obtained.

As described above, in the display device according to the first embodiment, a part provided on the first substrate 1, which part corresponds to the pillar-shaped spacers 8 provided on the second substrate 2 and is a portion of the second conductive layer 13 making the height of the first substrate 1 in the display area 10 differ from that of the second substrate 2 outside the display area 10, is removed thereby to make the gap between both the substrates in the display area 10 equal to the gap therebetween outside the display area 10. Thus, there is nonecessity for making the height of the pillar-shaped spacers 8 in the display area 10 differ from that of the pillar-shaped spacers 8 outside the display area 10.

Thus, the panel gap in the display area 10 and that outside the display area 10 can be made, without increasing the number of steps of a method of manufacturing the pillar-shaped spacers 8, to be uniform. Consequently, the display device adapted to suppress peripheral gap unevenness can be obtained.

### Second Embodiment

FIG. 6 is a partly cross-sectional explanatory view illustrating apart of a display device, in which pillar-shaped spacers are disposed, according to a second embodiment implementing the invention. In FIG. 6, the same reference numerals as used in FIGS. 1 to 5 designate the same or corresponding parts shown in FIGS. 1 to 5. The description of such parts is omitted herein.

The second embodiment differs from the first embodiment only in that the pillar-shaped spacers 8 disposed outside the display area 10 are disposed in a part corresponding to the hole 14b, which is provided in the first conductive layer 11, and to the hole 14a provided in the second conductive layer 13, which overlaps with the hole 14b. The second embodiment has an advantage corresponding to the hole 14b (to be described later), in addition to the advantages similar to those of the first embodiment.

The hole 14b provided in the first conductive layer 11 is formed in a part overlapping with the hole 11a provided in the second conductive layer 11 in the same step as the step of forming the first conductive layer 11. That is, the hole 14b is formed in the first conductive layer 11 in the same step as the step of forming the first conductive layer 11 in a part, which corresponds to the pillar-shaped spacers 8, in an area, in which the first conductive layer 11 and the second conductive layer 13 are stacked through the insulating layer 12, outside the display area 10. This hole 14b has a cross-section shaped concentrically with that of the pillar-shaped spacer 8 and also has a depth substantially equal to the thickness of the first conductive layer 11.

In a case where a removed part (that is, the hole 14b) of the first conductive layer 11 is large, the volume of the lines constituted by the first conductive layer 11 is reduced. Thus, the resistance of the lines is increased. There is a fear of deterioration of the display quality. Therefore, it is preferable that the cross-section of the removed part (the hole 14b) of the first conductive layer 11 is nearly equal to the cross-section of a region, in which the pillar-shaped spacer 8 is in contact with the array substrate, that is, the cross-section of a leading end of the pillar-shaped spacer 8.

However, in consideration of the overlapping deviation (that is, the bonding accuracy) between the first substrate 1 and the second substrate 2 and variation in the finish (that is, the exposure accuracy) of the pillar-shaped spacer 8, it is necessary to provide the holes 14b, which is formed by removing a part from the first conductive layer 11, not only in an area, in which the pillar-shaped spacer 8 provided on the counter substrate is in contact with the array substrate, but in an area broader than the area, in which the pillar-shaped spacer 8 is in contact with the array substrate. More specifically, it is preferable to remove an area whose cross-section is 1.5 to 4 times the cross-section of an end of the pillar-shaped spacer 8.

Incidentally, as described in the foregoing description of the first embodiment, the gap between both the substrates in the display area 10 can be adjusted to that therebetween outside the display area 10 by appropriately selecting the layers, in which the holes are formed, from the layers formed in the array substrate in which the pillar-shaped spacers 8.

As described above, the holes 14a and 14b are formed in the first conductive layer 11 and the second conductive layer 13 provided on the array substrate, which correspond to the pillar-shaped spacers 8 provided on the counter substrate. The height of the array substrate outside the display area 10 is set to be small, as compared with that of the array substrate in the display area 10. Also, the gap adjustment materials, such as the microrods, are mixed into the sealing material 3. Thus, the value of the panel gap outside the display area 10 can optionally be adjusted. Consequently, the display device having no peripheral gap unevenness can be obtained.

What is claimed is:

1. A display device comprising:
a first substrate on which a second conductive layer to be stacked on a first conductive layer through an insulating layer is formed;
a second substrate facing the first substrate; and
a pillar-shaped spacer that holds the first substrate and the second substrate so that a gap between the first substrate and the second substrate is substantially uniform, wherein
the pillar-shaped spacer is disposed above the first conductive layer, and
the pillar-shaped spacer is disposed above the first conductive layer through a hole provided in the second conductive layer in a region where the first conductive layer and the second conductive layer are stacked through the insulating layer.

2. The display device according to claim 1, wherein
the pillar-shaped spacer disposed inside a display area is disposed in a region where the second conductive layer is not stacked on the first conductive layer, and
the pillar-shaped spacer disposed outside the display area is disposed above the first conductive layer through the hole provided in the second conductive layer.

3. A display device comprising:
a first substrate on which a second conductive layer to be stacked on a first conductive layer through an insulating layer is formed;
a second substrate facing the first substrate;
a pillar-shaped spacer that holds the first substrate and the second substrate so that a gap between the first substrate and the second substrate is substantially uniform;
a sealing material adapted to seal liquid crystals in the gap between the first substrate and the second substrate, wherein
the sealing material is mixed with a gap adjustment material adapted to adjust the gap between the first substrate and the second substrate,
the pillar-shaped spacer disposed in a display area is disposed in a region where the second conductive layer is not stacked on the first conductive layer, above the first conductive layer, and
the pillar-shaped spacer disposed outside the display area is disposed in a region corresponding to an overlapping hole provided in the first conductive layer and in the second conductive layer.

4. The display device according to claim 1, wherein
the pillar-shaped spacer is not disposed in a transfer electrode portion adapted to conduct the first conductive layer provided on the first substrate to a common electrode provided on the second substrate.

5. The display device according to claim 1, wherein
the pillar-shaped spacer is not disposed in a region where a sealing material adapted to seal liquid crystals in the gap between the first substrate and the second substrate is applied.

6. The display device according to claim 1, further comprising:
an interlayer insulating film formed on the second conductive layer, wherein
the pillar-shaped spacer disposed outside a display area is disposed above the first conductive layer through a hole provided in the interlayer insulating film.

7. The display device according to claim 1, wherein
the pillar-shaped spacer disposed outside a display area is disposed above the first conductive layer through the hole provided in the insulating layer.

8. The display device according to claim 3, wherein
the pillar-shaped spacer is not disposed in a transfer electrode portion adapted to conduct the first conductive layer provided on the first substrate to a common electrode provided on the second substrate.

9. The display device according to claim 3, wherein
the pillar-shaped spacer is not disposed in a region where a sealing material adapted to seal liquid crystals in the gap between the first substrate and the second substrate is applied.

10. The display device according to claim 3, further comprising:
an interlayer insulating film formed on the second conductive layer, wherein
the pillar-shaped spacer disposed outside the display area is disposed above the first conductive layer through a hole provided in the interlayer insulating film.

11. The display device according to claim 3, wherein
the pillar-shaped spacer disposed outside the display area is disposed above the first conductive layer through the hole provided in the insulating layer.
